(19) United States
(12) Patent Application Publication
(10) Pub. No.: US 2019/0205116 A1
(43) Pub. Date: Jul. 4, 2019

(54) METHOD OF UPGRADING INVERTER SOWARE, SYSTEM AND ELECTRONIC DEVICE USING THE SAME

(71) Applicant: Delta Electronics (Shanghai) CO., LTD, Shanghai (CN)

(72) Inventors: Shen CHEN, Shanghai (CN); Feidong XU, Shanghai (CN); Xuancai ZHU, Shanghai (CN)

(73) Assignee: Delta Electronics (Shanghai) CO., LTD, Shanghai (CN)

(21) Appl. No.: 16/234,825

(22) Filed: Dec. 28, 2018

(30) Foreign Application Priority Data
Jan. 3, 2018 (CN) 201810004154.6

(51) Int. Cl. G06F 8/65; H04W 4/80; H04L 29/08

(52) U.S. Cl. CPC G06F 8/65; H04L 67/34; H04W 4/80

(57) ABSTRACT

A method of upgrading inverter software comprises: embedding a software upgrade package for software to be upgraded into an application package and uploading the application package to a server; obtaining the application package from the server through a terminal; obtaining version information of the software from an inverter to be upgraded through the terminal, wherein the terminal and the inverter are connected through a wireless communication; comparing the version information of the software from the inverter to be upgraded with version information of the software upgrade package in the application upgrade package through the terminal; if the comparison result is that the version information of the software to be upgraded is lower than the version information of the software upgrade package in the application upgrade package, sending the software upgrade package to the inverter through the terminal for the inverter to perform an upgrade operation.

### CROSS-REFERENCE TO RELATED APPLICATIONS

This application is based upon and claims priority to Chinese Patent Application No. 201810004154.6, filed on Jan. 3, 2018, the entire content of which is hereby incorporated by reference for all purposes.

### TECHNICAL FIELD

The present disclosure relates to the field of data communication technologies, and particularly to a method of upgrading inverter software, a system and an electronic device using the method.

### BACKGROUND

A photovoltaic inverter can convert direct current (DC) power into alternating current (AC) power, which is the core device of a photovoltaic power generation system. Due to some regulations, customer requirements or product maintenance requirements, photovoltaic inverters are required to be upgraded at times. At present, the existing software upgrade process for a photovoltaic inverter mainly relies on wired mode or gateway-based wireless mode, but these upgrade methods are not highly automatized, and require technicians to participate in the upgrade process.

In view of the above defect, it needs a method of upgrading inverter software, a system and an electronic device using the method to realize automatic upgrade of photovoltaic inverter software and simplify the upgrade operation.

It shall be noted that the above information disclosed in this background section is only for enhancement of understanding of the background of the present disclosure, therefore it may contain information that does not form the prior art that is already known to the ordinary skilled in the art.

### SUMMARY

An object of the present disclosure is to provide a method of upgrading inverter software, a system and an electronic device using the method, so as to overcome, at least to a certain extent, one or more problems caused by limitation and defects of related technologies.

According to a first aspect of the present disclosure, a method of upgrading inverter software is provided, including:

embedding a software upgrade package for software to be upgraded into an application package and uploading the application package to a server;

obtaining the application package from the server through a terminal;

obtaining version information of the software from an inverter to be upgraded through the terminal, wherein the terminal and the inverter are connected through a wireless communication;

comparing the version information of the software from the inverter to be upgraded with version information of the software upgrade package in the application upgrade package through the terminal; and

if the comparison result is that the version information of the software to be upgraded is lower than the version information of the software upgrade package in the application upgrade package, sending the software upgrade package to the inverter through the terminal for the inverter to perform an upgrade operation.

According to a second aspect of the present disclosure, a system of upgrading inverter software is provided, including a server; a terminal and an inverter, wherein the inverter is deployed with software to be upgraded, and wherein

the server, configured to receive an application package and send the application package, wherein a software upgrade package for software to be upgraded is embedded into the application package;

the terminal, configured to obtain the application package from the server, obtain version information of the software from the inverter to be upgraded through a wireless communication, compare the version information of the software from the inverter to be upgraded with the version information of the software upgrade package in the application upgrade package, and if the comparison result is that the version information of the software to be upgraded is lower than the version information of the software upgrade package in the application upgrade package, send the software upgrade package to the inverter; and

the inverter, configure to receive the software upgrade package sent by the terminal through the wireless communication, and perform an upgrade operation.

According to a third aspect of the present disclosure, an electronic device is provided, embedded in the inverter in the system of upgrading inverter software according to any of the above aspect, including:

an inverter system controller; and

a memory, configured to store executable instructions of the inverter system controller and the software upgrade package,

wherein the inverter system controller is configured to execute the executable instructions to cooperate with the inverter to perform the wireless communication.

In a technical solution provided by some embodiments of the present disclosure, a software upgrade package for software to be upgraded is embedded into an application package and uploaded the application package to a server. The application package is obtained from the server through a terminal. The terminal compares version information of the software from the inverter to be upgraded with version information of the software upgrade package. When the version information of the software to be upgraded is lower than the version information of the software upgrade package, the software upgrade package is sent to the inverter through the terminal for the inverter to perform an upgrade operation. On the one hand, the present disclosure realizes a solution for upgrading an inverter through a terminal, and the upgrade process is performed automatically without manual intervention; on the other hand, since the upgrade process does not require manual intervention, human mistakes can be avoided, and execution efficiency has been greatly increased.

It should be understood that the above general description and the detailed description below are merely exemplary and explanatory, and do not limit the present disclosure.

### BRIEF DESCRIPTION OF THE DRAWINGS

The accompanying drawings herein, which are incorporated in and constitute a part of this specification, illustrate embodiments consistent with the present disclosure, and, together with the description, serve to explain the principles of the present disclosure. Apparently; the accompanying drawings in the following description show merely some embodiments of the present disclosure, so the ordinary skilled in the art may further derive other drawings from these accompanying drawings without creative efforts.

FIG. 1 is a system block diagram schematically illustrating the inverter software upgrade according to prior art;

FIG. 2 is a flow chart schematically illustrating a method of upgrading inverter software according to an exemplary embodiment of the present disclosure.

FIG. 3 is a block diagram schematically illustrating the corresponding method of upgrading inverter software according to an exemplary embodiment of the present disclosure.

FIG. 4 is a block diagram schematically illustrating a system of upgrading inverter software according to an exemplary embodiment of the present disclosure.

FIG. 5 is a block diagram schematically illustrating an electronic device according to an exemplary embodiment of the present disclosure; and

FIG. 6 is a schematic diagram illustrating a storage medium according to an exemplary embodiment of the present disclosure.

### DETAILED DESCRIPTION

The exemplary embodiments will now be described more fully with reference to the accompanying drawings. However, the exemplary embodiments can be implemented in a variety of forms and should not be construed as limited to the embodiments set forth herein. Rather, the embodiments are provided so that the present disclosure will be thorough and complete and will fully convey the concepts of exemplary embodiments to those skilled in the art. The features, structures, or characteristics described may be combined in one or more embodiments in any suitable manner. In the following description, numerous specific details are provided to give a full understanding of the embodiments of the present disclosure. Those skilled in the art will recognize, however, that the technical solution of the present disclosure may be practiced without one or more of the specific details described, or that other methods, components, materials, etc., may be employed. In other instances, well-known technical solutions are not shown or described in detail to avoid obscuring aspects of the present disclosure.

In addition, the accompanying drawings are merely exemplary illustration of the present disclosure, and are not necessarily drawn to scale. The same reference numerals in the drawings denote the same or similar parts, and thus repeated description thereof will be omitted. Some block diagrams shown in the figures are functional entities and not necessarily to be corresponding to a physically or logically individual entities. These functional entities may be implemented in software form, or implemented in one or more hardware modules or integrated circuits, or implemented in different networks and/or processor apparatuses and/or microcontroller apparatuses.

The flowcharts shown in the figures are merely illustrative and not necessarily include all of the steps. For example, some steps may be decomposed, and some steps may be combined or partially merged, so the actual execution order may vary, depending on the actual situation.

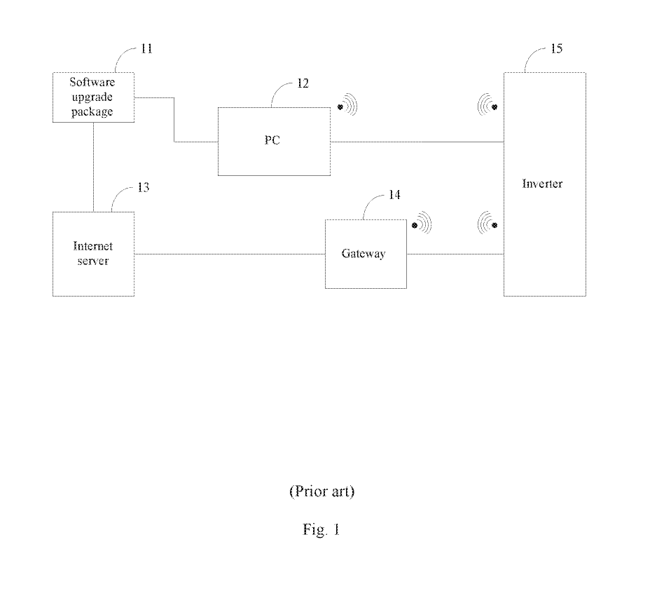

A photovoltaic inverter upgrade process of some existing technologies will be described with reference to FIG. 1. First, a developer can develop a software upgrade package (FW (Firmware) Package) 11 based on requirements; next, on the one hand, the upgrade can be performed through the PC 12, that is, the software upgrade package 11 is uploaded to the PC 12, and the PC 12 can establish a connection to the inverter 15 through for example a wire communication interface or a wireless manner. On the other hand, the upgrade can be performed through the gateway 14, that is, the software upgrade package 11 is uploaded to the Internet server 13, the Internet server 13 can establish a connection with the gateway 14 through the Ethernet, then the gateway 14 can establish a connection with the inverter 15 through for example a wire communication interface or a wireless manner. Consequently, in the case of upgrade through the PC terminal 12, operators in the filed can invoke a corresponding upgrade tool through the PC terminal 12 to start the software upgrade process of the inverter 15, and wait for the software upgrade to be completed. In the case of upgrade through the gateway 14, the operators in the background can invoke a corresponding upgrade tool in the background to start the software upgrade process of the inverter 15, and wait for the software upgrade to be completed.

It can be seen that the existing upgrade processes require manual intervention by operators (operators in the filed or in the background), and the process is complicated. Therefore, a new method of upgrading inverter software is provided in the exemplary embodiments of the present disclosure.

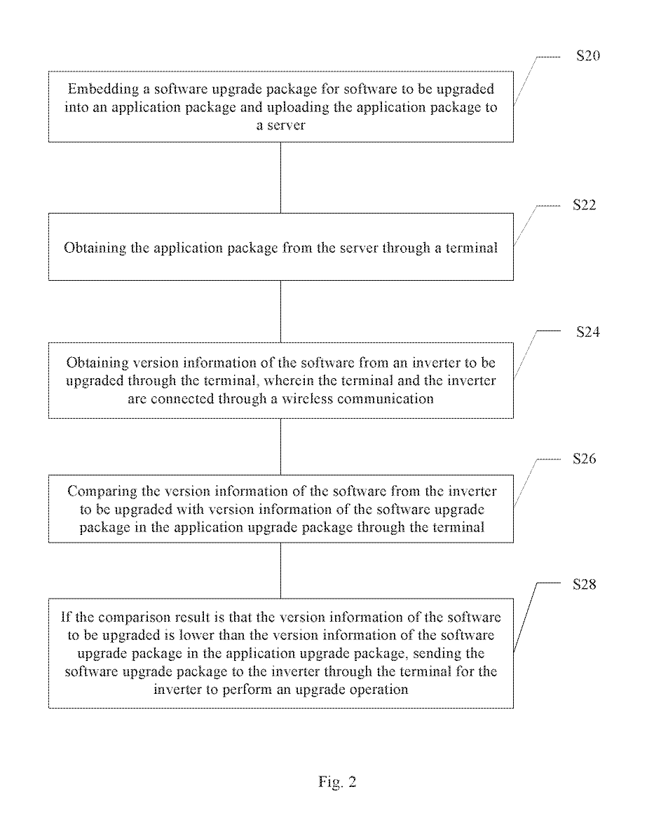

FIG. 2 is a flow chart of schematically illustrating a method of upgrading inverter software according to an exemplary embodiment of the present disclosure. Referring to FIG. 2, the method of upgrading inverter software may include the following steps S20-S28.

In step S20, a software upgrade package for software to be upgraded is embedded into an application package, to be uploaded to a server.

In step S22, the application package is obtained from the server through a terminal.

In step S24, version information of the software from an inverter to be upgraded is obtained through the terminal, wherein the terminal and the inverter are connected through wireless communication.

In step S26, the terminal compares the version information of the software from the inverter to be upgraded with version information of the software upgrade package in the application upgrade package.

In step S28, if the comparison result is that the version information of the software to be upgraded is lower than the version information of the software upgrade package in the application upgrade package, the software upgrade package is sent to the inverter through the terminal for the inverter to perform an upgrade operation.

In the method of upgrading inverter software of the present disclosure, a software upgrade package is embedded into an application package to be uploaded to a server. The application package is obtained from the server through a terminal. The terminal compares the version information of the software from the inverter to be upgraded with the version information of the software upgrade package. When the version information of the software to be upgraded is lower than the version information of the software upgrade package, the software upgrade package is sent to the inverter through the terminal for the inverter to perform an upgrade operation. On the one hand, the present disclosure realizes a solution for upgrading an inverter through a terminal, and the upgrade process is performed automatically without manual intervention. On the other hand, since the upgrade process does not require manual intervention, human mistakes can be avoided, and execution efficiency has been greatly increased.

Each step will be specifically explained below. In the step S20, a software upgrade package for software to be upgraded is embedded into an application package, to be uploaded to a server.

In an exemplary embodiment of the present disclosure, the software to be upgraded can be software required for the inverter to work. During the working operation of the inverter, due to some changes in regulations or rules, or changes of customer requirements, or the requirement for maintenance of the inverter itself, the software corresponding to the inverter should be upgraded.

Specifically, first, a developer can determine the upgrade requirement corresponding to the above upgrade reason, and subsequently, the developer can write a software upgrade package for the software to be upgrade according to the upgrade requirement. The disclosure does not specifically limit the process of writing the software upgrade package by the developer specifically and the content of the software upgrade package. The written software upgrade packages can be used to fix bugs of the software of the inverter or provide new functions for the inverter.

Next, the software upgrade package can be embedded into an application package. The application package may be received by the terminal and may be used to obtain information by the terminal. The specific type of the application package is not specifically limited in the present disclosure. In addition, the process of embedding the software upgrade package into the application package may be the same as the existing program embedding process, which will not be repeated herein.

Consequently, the application package in which the software upgrade package is embedded can be uploaded to the server on the development side. The server may be an application store server, or the server may be another server being capable of communicating with the terminal.

In addition, when the application package in which the software upgrade package is embedded is uploaded to the server, the application package can be encrypted, and only the terminal, which has obtained the password or specified by the encryption program, can obtain the application package from the server; and/or the software upgrade package can be encrypted during the process of embedding the software upgrade package into the application package, and only the specified terminal can extract the software upgrade package from the application package.

In the step S22, the application package is obtained from the server through the terminal.

The terminal described in the present disclosure may refer to a mobile phone, but not limited thereto. The terminal may further include a portable terminal such as a tablet computer, and in addition, the terminal may further include a fixed terminal having a wireless communication function, which is not particularly limited in the exemplary embodiment.

In an exemplary embodiment of the present disclosure, when the server receives the application package in which the software upgrade package is embedded, the server can initiatively send the application package to the terminal.

In addition, after receiving the application package, the server may send a notification instruction to the terminal, the terminal may send an acquisition request to the server in response to the notification instruction, and the server may send the application package to the terminal in response to the acquisition request.

According to some other embodiments, the terminal may periodically monitor whether the server has an application package. After recognizing that the server has an application package, the terminal may send an acquisition request to the server, and the server sends the application package to the terminal in response to the acquisition request.

In step S24, the version information of the software from the inverter to be upgraded is obtained through the terminal, wherein the terminal and the inverter are connected through the wireless communication.

In an exemplary embodiment of the present disclosure, a wireless communication module can be configured in the inverter previously. Specifically, the inverter can be equipped with a. Bluetooth unit. Bluetooth communication will be described below as a specific manner of the wireless communication of the present disclosure, however, it will be readily understood that the present disclosure may further use other short-distance wireless communication technology, such as the ZigBee.

In addition, in order to work properly with the Bluetooth unit, it is necessary to configure a corresponding Microcontroller Unit (MCU) as an inverter system controller. The MCU can be the original MCU of the inverter. However, it is possible to newly add another MCU to the inverter separately.

The terminal can obtain the version information of the software to be upgraded from the inverter through the Bluetooth communication. For example, the version information is 5.2.

In step S26, the terminal compares the version information of the software from the inverter to be upgraded with the version information of the software upgrade package in the application upgrade package.

The terminal compares the version information of the software from the inverter to be upgraded with the version information of the software upgrade package in the application upgrade package. Specifically, since some version information may include character string other than numbers and has a long length, the version information may be compared by using a byte-by-byte comparison method.

In step S28, if the comparison result is that the version information of the software to be upgraded is lower than the version information of the software upgrade package in the application upgrade package, the software upgrade package is sent to the inverter through the terminal for the inverter to perform the upgrade operation.

In an exemplary embodiment of the present disclosure, if the comparison result is that the version information of the software to be upgraded is lower than the version information of the software upgrade package in the application upgrade package, the software upgrade package is sent to the inverter through the terminal. Specifically, the terminal can send the software upgrade package to the inverter through the Bluetooth communication. For example, the version information of the software to be upgraded obtained from the inverter is 5.2, and the version information of the software upgrade package is 6.0, then the terminal can send the software upgrade package to the inverter. In addition, an external memory can be configured in the inverter to store the software upgrade package, wherein the external memory can be the original memory of the inverter or another newly-added memory.

In an exemplary embodiment of the present disclosure, when the software upgrade package is sent to the inverter through the terminal, the terminal may execute a prompt event to inform the user to wait. The prompt event may be, for example, displaying a waiting prompt message on the screen of the mobile phone, and/or giving off a voice prompt from the mobile phone, etc.

In addition, after receiving the software upgrade package sent by the terminal, the inverter may detect the integrity of the software upgrade package, and only when it confirms that the software upgrade package is complete, the inverter performs the upgrade operation. If the inverter detects that the software upgrade package is incomplete, an alarm message is sent to the terminal through the Bluetooth unit, so that the terminal resends the software upgrade package. In addition, if, after a plurality of transmissions, the terminal still receives the alarm message sent by the inverter, the terminal can send feedback to the developer by way of mail or text message, so that the developer can determine the specific cause of the failure.

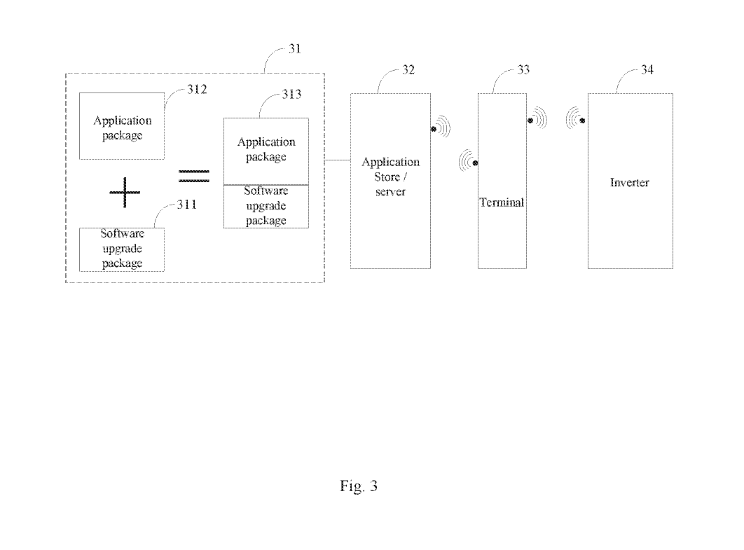

The method of upgrading inverter software of the present disclosure will be described below with reference to FIG. 3. First, the software upgrade package 311 can be embedded into the application package 312 on the development side 31, to obtain the application package 313 in which the software upgrade package is embedded; then the application package 313 can be upload to the server 32, wherein the server 32 can be an application store server, or the server 32 may be another server being capable of communicating with the terminal; subsequently, the server 32 can send the application package 313 to the mobile phone 33 through the mobile network; next, the mobile phone 33 obtains the version information of the software to be upgraded from the inverter 34 through the Bluetooth communication and compares the version information of the software to be upgraded with the version information of the software upgrade package 311 in the application package 313. When the comparison result is that the version information of the software to be upgraded to be lower than the version information of the software upgrade package 311, the mobile phone 33 may send the software upgrade package 311 to the inverter 34 through the Bluetooth communication. In addition, after determining that the received software upgrade package is complete, the inverter 34 performs the upgrade operation based on the software upgrade package. Thereby, the entire process of the inverter software upgrade is completed.

It should be noted that, although the respective steps of the method of the present disclosure are described in a particular order in the drawings, this does not require or imply that the steps must be performed in this specific order, or that the desired result can be achieved only after all the steps shown are performed. Additionally or alternatively, certain steps may be omitted, and/or a plurality of steps may be combined into one step to perform, and/or one step may be decomposed into a plurality of steps to perform, and the like.

Further, a system of upgrading inverter software is provided in the exemplary embodiment.

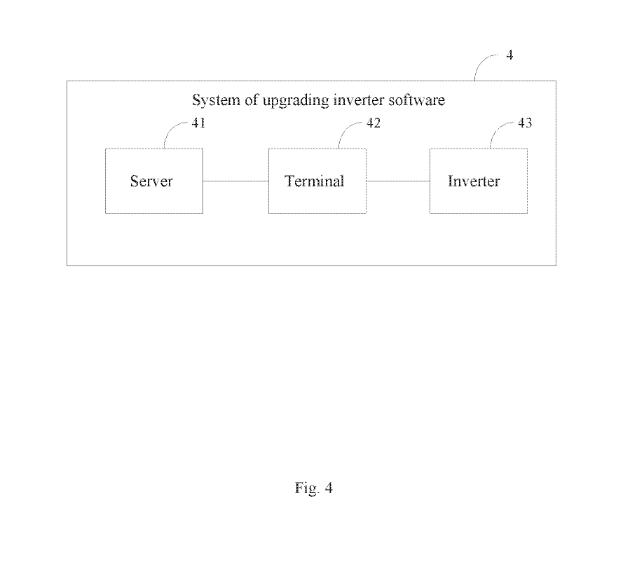

FIG. 4 is a block diagram schematically illustrating a system of upgrading inverter software according to an exemplary embodiment of the present disclosure. Referring to FIG. 4, the system of upgrading inverter software 4 according to an exemplary embodiment of the present disclosure may include a server 41, a terminal 42 and an inverter 43 deployed with software to be upgraded.

The server 41 is configured to receive an application package and send the application package, wherein a software upgrade package for software to be upgraded is embedded into the application package.

The terminal 42 is configured to acquire the application package from the server 41, and obtains version information of the software from the inverter 43 to be upgraded through a wireless communication, and compares version information of the software to be upgraded with version information of the software upgrade package in the application upgrade package. If the version information of the software to be upgraded is lower than the version information of the software upgrade package in the application upgrade package, the software upgrade package is sent to the inverter 43.

The inverter 43 is configured to receive the software upgrade package sent by the terminal 42 through the wireless communication and perform an upgrade operation.

According to the system of upgrading the inverter software of the present disclosure, on the one hand, the present disclosure realizes a solution for upgrading an inverter through a terminal, and the upgrade process is performed automatically without manual intervention; on the other hand, since the upgrade process does not require manual intervention, human mistakes can be avoided, and execution efficiency can be greatly increased.

According to an exemplary embodiment of the present disclosure, both the terminal and the inverter are equipped with a Bluetooth unit, and the wireless communication is the Bluetooth communication, to realize the solution for upgrading the inverter through a manner of the Bluetooth communication.

According to an exemplary embodiment of the present disclosure, the terminal is further configured to execute a prompt event to inform the user to wait when the software upgrade package is being sent to the inverter.

In the embodiment, by informing the user to wait, the conditions that the user leaves or shuts down the terminal when the transmission is not completed can be avoided, thereby the integrity of transmission of the software upgrade package can be ensured.

According to an exemplary embodiment of the present disclosure, after receiving the software upgrade package sent by the terminal, the inverter detects the integrity of the software upgrade package, and only when it confirms that the software upgrade package is complete, the inverter can perform the upgrade operation.

In the embodiment, a verification mechanism for the software upgrade package is provided to ensure that the software upgrade package can be completely transmitted to the inverter to perform the upgrade operation.

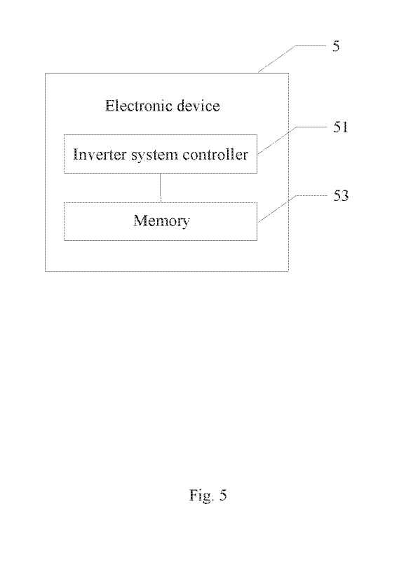

According to an exemplary embodiment of the present disclosure, an electronic device is further provided. The electronic device can be embedded into the inverter described above. Referring to FIG. 5, the electronic device 5 may include an inverter system controller 51 and a memory 53, wherein the memory 53 is configured to store executable instructions for the inverter system controller 51 and the software upgrade package, and the inverter system controller 51 may be a microprocessor and is configured to execute the executable instructions to cooperate with the inverter to perform the wireless communication. Additionally, the memory 53 can include readable and writable media with volatile memory cells.

According to an exemplary embodiment of the present disclosure, a readable and writable storage medium is further provided, on which a program product is stored, being capable of implementing the above method of the present specification. In some possible implementations, the respective aspects of the present disclosure may further be realized in a form of a program product comprising program code, and when the program product runs on a terminal device, the program code is configured to cause the terminal device to perform the steps according to various exemplary embodiments of the present disclosure described in the “detailed description” section of the present specification.

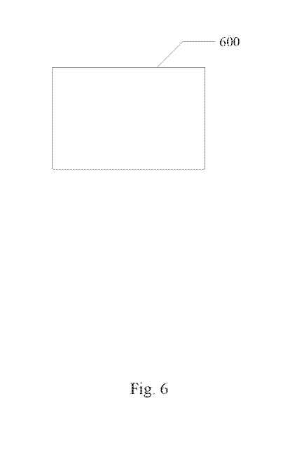

Referring to FIG. 6, which illustrates a program product 600 for implementing the above method according to an exemplary embodiment of the present disclosure, the program product 600 is a readable and writable medium and includes program code, and can run on a terminal device, such as a personal computer. However, the program product of the present disclosure is not limited thereto, and in this document, the readable and writable storage medium may be any tangible medium containing or storing a program that can be used by or in conjunction with an instruction execution system, apparatus or device.

The program product can take any combination of one or more readable and writable media. The readable and writable medium can be readable and writable signal medium or readable and writable storage medium. The readable and writable storage medium can be, for example, but not limited to, an electronic, magnetic, optical, electromagnetic, infrared, or semiconductor system, apparatus, or device, or any combination of the above. More specific examples (non-exhaustive lists) of readable and writable storage media include: electrical connections having one or more wires, hard disks, flash memories, optical fibers, optical storage devices, magnetic storage devices, or any suitable combination of the foregoing.

The readable and writable signal medium can include a data signal that is propagated in the baseband or as part of a carrier, in which the program code is carried. Such propagated data signals can take a variety of forms including, but not limited to, electromagnetic signals, optical signals, or any suitable combination of the foregoing. The readable and writable signal medium can be any readable and writable medium other than a readable and writable storage medium, which can transmit, propagate, or transport a program for use by or in connection with an instruction execution system, apparatus, or device.

Program code included on the readable and writable medium can be transmitted by using any suitable medium, including but not limited to wireless, wired, optical cable, RF, etc., or any suitable combination of the foregoing.

Program code for performing the operations of the present disclosure may be written in any combination of one or more programming languages, including an object oriented programming language such as Java, C++, etc., or including conventional procedural programming language such as the “C” language or a similar programming language. The program code can execute entirely on the user's computing device, partially on the user's device, as a standalone software package, partially on the user's computing device and partially on the remote computing device, or entirely on the remote computing device or a server. In the case of a remote computing device, the remote computing device can be connected to the user's computing device via any kind of network, including a local area network (LAN) or a wide area network (WAN), or can be connected to an external computing device (e.g., using an Internet service provider to connect via the Internet).

Through the description of the above embodiments, those skilled in the art will readily understand that the example embodiments described herein may be implemented by software or by software in combination with necessary hardware. Therefore, the technical solution according to an embodiment of the present disclosure may be embodied in a form of a software product, which may be stored in a non-volatile storage medium or on a network, including a plurality of instructions to cause a microprocessor, a server, a terminal device or a network device or the like performs a method according to an embodiment of the present disclosure.

Further, the above-described drawings are merely illustrative of the processes included in the method according to the exemplary embodiments of the present disclosure, and are not intended to be limiting. It is easy to understand that the processing shown in the above figures does not indicate or limit the chronological order of these processes. In addition, it is also easy to understand that these processes may be performed for example, synchronously or asynchronously in a plurality of modules.

It should be noted that, although several modules or units of equipment for action execution are mentioned in the detailed description above, such division is not mandatory. In fact, in accordance with the embodiments of the present disclosure, features and functions of two or more of the modules or units described above may be embodied in one module or unit, or the features and functions of one module or unit described above may be further divided into a plurality of modules or units.

Other embodiments of the present disclosure will be apparent to those skilled in the art from consideration of the specification and practice of the present disclosure disclosed here. This application is intended to cover any variations, uses, or adaptations of the present disclosure following the general principles thereof and including the common sense and the commonly-used technology means in the related field not disclosed in the present disclosure. It is intended that the specification and embodiments be considered as exemplary only, with a scope of the present disclosure being indicated by the following claims.

It will be appreciated that the present disclosure is not limited to the exact construction that has been described above and illustrated in the accompanying drawings, and that various modifications and changes can be made without departing from the scope thereof. The scope of the present disclosure is only restricted by the appended claims.

What is claimed is:

1. A method of upgrading inverter software, comprising:
embedding a software upgrade package for software to be upgraded into an application package, and uploading the application package to a server;
obtaining the application package from the server through a terminal;
obtaining version information of the software from an inverter to be upgraded through the terminal, wherein the terminal and the inverter are connected through a wireless communication;
comparing the version information of the software from the inverter to be upgraded with version information of the software upgrade package in the application upgrade package through the terminal; and
if a comparison result is that the version information of the software to be upgraded is lower than the version information of the software upgrade package in the application upgrade package, sending the software upgrade package to the inverter through the terminal for the inverter to perform an upgrade operation.

2. The method of upgrading inverter software according to claim 1, wherein both the terminal and the inverter are equipped with a Bluetooth unit, and the wireless communication is a Bluetooth communication,
wherein the step of obtaining version information of the software from an inverter to be upgraded through the terminal comprises:
obtaining the version information of the software from the inverter to be upgraded through the terminal by the Bluetooth communication.

3. The method of upgrading inverter software according to claim 2, wherein the step of sending the software upgrade package to the inverter through the terminal comprises:
sending the software upgrade package to the inverter through the terminal by the Bluetooth communication.

4. The method of upgrading inverter software according to claim 1, further comprising:
when the software upgrade package is being sent to the inverter through the terminal, executing a prompt event by the terminal to inform the user to wait.

5. The method of upgrading inverter software according to claim 1, further comprising:
after the inverter receives the software upgrade package sent by the terminal, detecting integrity of the software upgrade package by the inverter, and when it confirms that the software upgrade package is complete, performing the upgrade operation by the inverter.

6. A system of upgrading inverter software, including a server, a terminal and an inverter, wherein the inverter is deployed with software to be upgraded, and wherein
the server, configured to receive an application package and send the application package, wherein a software upgrade package for software to be upgraded is embedded into the application package;
the terminal, configured to obtain the application package from the server, obtain version information of the software from the inverter to be upgraded through a wireless communication, compare the version information of the software from the inverter to be upgraded with the version information of the software upgrade package in the application upgrade package, and if the comparison result is that the version information of the software to be upgraded is lower than the version information of the software upgrade package in the application upgrade package, send the software upgrade package to the inverter; and
the inverter, configure to receive the software upgrade package sent by the terminal through the wireless communication, and perform an upgrade operation.

7. The system of upgrading inverter software according to claim 6, wherein both the terminal and the inverter are equipped with a Bluetooth unit, and the wireless communication is a Bluetooth communication.

8. The system of upgrading inverter software according to claim 6, wherein, when the software upgrade package is being sent to the inverter through the terminal, a prompt event is executed by the terminal to inform the user to wait.

9. The system upgrading inverter software according to claim 6, wherein, after the inverter receives the software upgrade package sent by the terminal, the inverter detects integrity of the software upgrade package, and only when it confirms that the software upgrade package is complete, the inverter performs the upgrade operation.

10. An electronic device, embedded in the inverter in the system of upgrading inverter software according to claim 6, comprising:
an inverter system controller; and
a memory, configured to store executable instructions for the inverter system controller and the software upgrade package, wherein
the inverter system controller is configured to execute the executable instructions to cooperate with the inverter to perform the wireless communication.

11. The electronic device according to claim 10, wherein the inverter system controller is a microprocessor.
